(19) United States
(12) Patent Application Publication
(10) Pub. No.: US 2017/0122647 A1
(43) Pub. Date: May 4, 2017

(54) COMPACT LIQUID COOLED, AIR THROUGH GALLEY CHILLER

(71) Applicant: B/E AEROSPACE, INC., Wellington, FL (US)

(72) Inventor: Peter John Leslie BURD, Carmarthenshire (GB)

(73) Assignee: B/E AEROSPACE, INC., Wellington, FL (US)

(21) Appl. No.: 15/406,688

(22) Filed: Jan. 14, 2017

Related U.S. Application Data
(63) Continuation-in-part of application No. 14/754,593, filed on Jun. 29, 2015.
(60) Provisional application No. 62/022,113, filed on Jul. 8, 2014.

(51) Int. Cl. F25D 17/06; B64D 13/08; F25D 25/00; B64D 11/04; F25D 15/00; F25D 29/00

(52) U.S. Cl. CPC F25D 17/06; F25D 15/00; F25D 29/003; F25D 25/005; B64D 11/04; B64D 13/08

(57) ABSTRACT

The present disclosure is related, in certain embodiments, to a chilled air distribution system for an aircraft, with a reduced overall foot print and reduced weight, and with an improved overall heat transfer efficiency. The compact lightweight system of certain embodiments is particularly well suited for an aircraft galley that requires refrigerated or cooled carts or trolleys, and/or carts carrying standard meal boxes, and/or chilled food and beverage compartments.

### CROSS-REFERENCE TO RELATED APPLICATIONS

This application is a continuation-in-part of and claims priority to U.S. application Ser. No. 14/754,593 entitled “Compact Liquid Cooled, Air Through Galley Chiller” and filed Jun. 29, 2015, which claims priority to U.S. Provisional Application No. 62/022,113, filed Jul. 8, 2014, the contents of both which are incorporated by reference in their entireties.

### BACKGROUND

Large commercial passenger-carrying aircraft have galleys for preparing serving food and beverages during the flight. These galleys are equipped with ovens, beverage makers, trash compactors, and various other kitchen type appliances used in the preparation and serving of the food and beverages. The galley also includes carts or trolleys that can be rolled down the aisles of the aircraft to serve meals and beverages to the passengers. As with all aircraft systems, these galleys and the equipment used therein must adhere to guidelines for weight and space, which are both premiums on an aircraft. As part of the food and beverage service, perishables are stored and then served on the flight. Perishables create a problem for aircraft operators because traditional refrigeration systems are too heavy and take up too much space to function in the aircraft galley. Thus, the aircraft manufactures must design a way to keep the perishables fresh during flight without refrigerators on the aircraft.

To this end, most commercial aircraft employ one of two types of systems for keeping perishable food stuffs and non-perishable drinks at desired temperatures from loading to service on the flight. The first method utilizes vapor cycle based air chillers that utilize conventional refrigerant gas compression and expansion technology to generate a secondary recirculated chilled air loop. The chilled air is generally supplied and returned via a thermally insulated air ducting to and from a suitable storage structure, such as the galley. The air chiller may be located on or in the galley or mounted in part of the aircraft airframe.

The second method utilizes the same conventional refrigerant gas compression and expansion technology, but the cooling medium is a chilled liquid rather than a gas. This chilled liquid is pumped in a closed loop to and from a suitable storage structure, such as a galley. The chilled liquid in some cases is delivered from a large centralized system throughout the whole aircraft. In other cases, the chilled liquid can be circulated at each separate aircraft galley structure to establish a local area chilling loop, or be based on each individual galley as a standalone system. At the galley, the liquid is passed via a control valve and an electronic control system to a heat exchanger, where an electric axial (or other) fan blows or sucks air through its matrix around enclosed areas of the storage structure that requires chilling, for example: a galley cart bay or compartment. The heat exchanger fan and its control system (though not necessarily all) are grouped together to form a chilled air recirculation unit that may be fitted in the galley or remotely spaced from it.

One drawback of these various chiller systems is that they still take up a large percentage of available space in the galley. Further, the chillers tend to be very heavy, which is also a drawback to their use on aircraft. There are also issues with condensation collection and removal, and the need for improvements in heat transfer efficiency. Further, air control flaps are necessary to reduce the loss of chilled air, which makes the system more inefficient. Accordingly, it would be beneficial to have a chiller system that takes up less space and reflects a reduction in weight over conventional chiller systems currently in use, while providing for condensation collection and improved heat transfer efficiency.

### SUMMARY OF ILLUSTRATIVE EMBODIMENTS

The present disclosure is related, in certain embodiments, to a chilled air distribution system for an aircraft, with a reduced overall foot print and reduced weight, and with an improved overall heat transfer efficiency. The compact lightweight system of certain embodiments is particularly well suited for an aircraft galley that requires refrigerated or cooled carts or trolleys, and/or carts carrying standard meal boxes, and/or chilled food and beverage compartments. Various embodiments of the chiller system of the present disclosure include a vertically oriented cooling unit adjacent the beverage carts and below the work deck (countertop) of the aircraft galley, which includes ducting leading away from the beverage cart storage to carry away heated air during the cooling process. An interlock may connect the system in the presence of the beverage/meal cart, and when the beverage/meal cart is removed, the interlock cooperates to turn off the fans that distribute the chilled air, and divert the chilled refrigerant through a bypass loop. This design can eliminate the need for fitting of an air outlet and inlet with self-closing flap valves.

The air cooled module, in some embodiments, is vertically oriented and positioned in the compartment where the beverage/food carts are housed in the galley below the work deck. In a preferred embodiment, the module is mounted to the back wall of the compartment and adds a depth of no more than 1.65 inches (42 mm). Conduits distribute chilled coolant between the heat exchanger of the module and a chilled liquid distribution manifold that is located the top of the compartment, and fed from aircraft piping in the galley central column or from another available location.

The cooling module may take the form of a galley LRU (Line Replaceable Unit), and it may incorporate air to liquid heat exchangers for chilling the recirculated air passing through the associated beverage cart. In another preferred embodiment, the cooling module may include defrosting heaters for clearing ice from the heat exchanger and other components when necessary. In such cases, it is preferable to include automatic drain valves to allow condensation to be removed from the bottom of the module's housing and directed to the aircraft's waste water system.

A feature of some illustrative embodiments is the incorporation of an electric three way divert or proportioning valve that controls the flow of refrigerant liquid through the heat exchanger, taking into consideration the temperature requirements of each individual chilled cart compartment. One or more axial fans may be provided to recirculate the chilled air around the inside of the installed cart. [RAC1] The control of the module, in one example, is effected by a local control box, including relays that communicate signals to and from a common galley mounted controller (e-box). Easily detachable power and data cables can be routed to and from the unit and feed information about the system to the main galley controller. Anti-vibrational measures can be incorporated as well to prevent vibrations from being transmitted to the galley structure, such as elastic mounts that dampen vibration from various sources.

The location of various embodiments of a compact liquid cooled, air through galley chiller can play a useful role in both the galley foot print and weight reduction, as well as the efficient distribution of chilled air around the below work deck installed trolley or cart. The through work deck air path, ductwork and air guiding devices may be positioned for the efficient use of the chilled air to meet the certification requirements of the aircraft manufacturers.

Other features and advantages of compact liquid cooled, air through galley chillers will become more apparent from the following detailed description of the illustrative embodiments in conjunction with the accompanying drawings, which illustrate by way of example the operation of the described embodiments. It is an object of the disclosure to provide a galley chiller for disposition in a galley compartment of an aircraft and for refrigerating a cart, including an inlet to receive a cooling medium from a cooling system, an outlet to evacuate the cooling medium, a three way proportioning valve connected to the inlet for splitting the cooling medium into a first amount of cooling medium and a second amount of cooling medium, and channeling the first amount of cooling medium into a heat exchanger and the second amount of cooling medium into a bypass line, a flow distribution block connected for collecting the first quantity of cooling medium and the second quantity of cooling medium, and for channeling the cooling medium to the outlet, a return port for receiving warm air from an internal volume of the cart, a supply port for expulsing cool air onto the internal volume of the cart, fans for circulating the warm air over the heat exchanger and for providing the cool air at an air flow rate, and a controller configured to provide, via sensors, refrigeration conditions of the cart and to adjust the first quantity of cooling medium and the air flow rate, via the three way proportioning valve and the fans, based on the refrigeration conditions.

It is another object of the disclosure to provide a galley chiller for disposition in a galley compartment of an aircraft and for refrigerating a container with perishable items including an inlet to receive a cooling medium from a cooling system, an outlet to evacuate the cooling medium, a three way proportioning valve connected to the inlet for splitting the cooling medium into a first amount of cooling medium and a second amount of cooling medium, and channeling the first amount of cooling medium into a heat exchanger and the second amount of cooling medium into a bypass line, a flow distribution block connected for collecting the first quantity of cooling medium and the second quantity of cooling medium, and for channeling the cooling medium to the outlet, a return port for receiving warm air from an external volume of the container, a supply port for expulsing cool air onto the external volume of the container, fans for circulating the warm air over the heat exchanger and for providing the cool air at an air flow rate, and a controller configured to provide, via sensors, refrigeration conditions of the container and to adjust the first quantity of cooling medium and the air flow rate, via the three way proportioning valve and the fans, based on the refrigeration conditions.

It is another object of the present disclosure to provide a galley of an aircraft, including a work deck and a cart chiller for providing air through refrigeration of a cart placed inside a cart compartment located below the work deck, a compartment chiller for providing air around refrigeration of a deck compartment located above the cart compartment, and a meal box chiller for providing air around refrigeration of meal boxes located above the deck compartment. The at least of one the cart chiller, the compartment chiller, and the meal box chiller may have an inlet to receive a cooling medium from a cooling system, an outlet to evacuate the cooling medium, a three way proportioning valve connected to the inlet for splitting the cooling medium into a first amount of cooling medium and a second amount of cooling medium, and channeling the first amount of cooling medium into a heat exchanger and the second amount of cooling medium into a bypass line, a flow distribution block connected for collecting the first quantity of cooling medium and the second quantity of cooling medium, and for channeling the cooling medium to the outlet, a return port for receiving warm air, a supply port for expulsing cool air, fans for circulating the warm air over the heat exchanger and for providing the cool air at an air flow rate, and a controller configured to provide, via sensors, refrigeration conditions of the cart and to adjust the first quantity of cooling medium and the air flow rate, via the three way proportioning valve and the fans, based on the refrigeration conditions.

Embodiments of the disclosure can include one or more or any combination of the above features and configurations.

Additional features, aspects and advantages of the disclosure will be set forth in the detailed description which follows, and in part will be readily apparent to those skilled in the art from that description or recognized by practicing the innovations as described herein. It is to be understood that both the foregoing general description and the following detailed description present various embodiments, and are intended to provide an overview or framework for understanding the nature and character of the invention as it is claimed. The accompanying drawings are included to provide a further understanding of the various innovations, and are incorporated in and constitute a part of this specification.

### BRIEF DESCRIPTION OF THE DRAWINGS

A more complete appreciation of the innovations and many of the attendant advantages thereof will be readily obtained as the same becomes better understood by reference to the following detailed description when considered in connection with the accompanying drawings, where:

FIG. 1A is a sectional view of an example galley with cart chillers and carts fed by a cooling system, according to certain aspects of the present disclosure;

FIG. 1B is a front view of an example galley with cart chillers and without the carts fed by a cooling system, according to certain aspects of the present disclosure;

FIG. 2 is a front view of an example cart chiller without a housing, according to certain aspects of the present disclosure;

FIG. 3A is a first side view of an example cart chiller, according to certain aspects of the disclosure;

FIG. 3B is a second side view of the example cart chiller of FIG. 3A, according to certain aspects of the disclosure;

FIG. 4 is a flow chart of an example method for monitoring and adjusting refrigeration through the cart chiller, according to certain aspects of the disclosure;

FIG. 5 is a sectional view of an example galley with the cart chillers, compartment chillers, and meal box chillers, according to certain aspects of the disclosure; and

FIG. 6 is a schematic view of a hardware diagram of an example controller for monitoring and adjusting the refrigeration, according to certain aspects of the disclosure.

### DETAILED DESCRIPTION OF ILLUSTRATIVE EMBODIMENTS

All publications, patent applications, patents, and other references mentioned herein are incorporated by reference in their entirety. Further, the materials, methods, and examples discussed herein are illustrative only and are not intended to be limiting.

In the drawings, like reference numerals designate identical or corresponding parts throughout the several views. Further, as used herein, the words “a”, “an”, and the like include a meaning of “one or more”, unless stated otherwise. The drawings are generally drawn not to scale unless specified otherwise or illustrating schematic structures or flowcharts.

The present illustrative embodiments will now be described more fully hereinafter with reference to the accompanying drawings in which exemplary embodiments of the disclosure are shown. However, the innovations may be embodied in many different forms and should not be construed as limited to the representative embodiments set forth herein. The exemplary embodiments are provided so that this disclosure will be both thorough and complete, and will fully convey the scope of the innovations and enable one of ordinary skill in the art to make, use and practice the innovations. Like reference numbers refer to like elements throughout the various drawings.

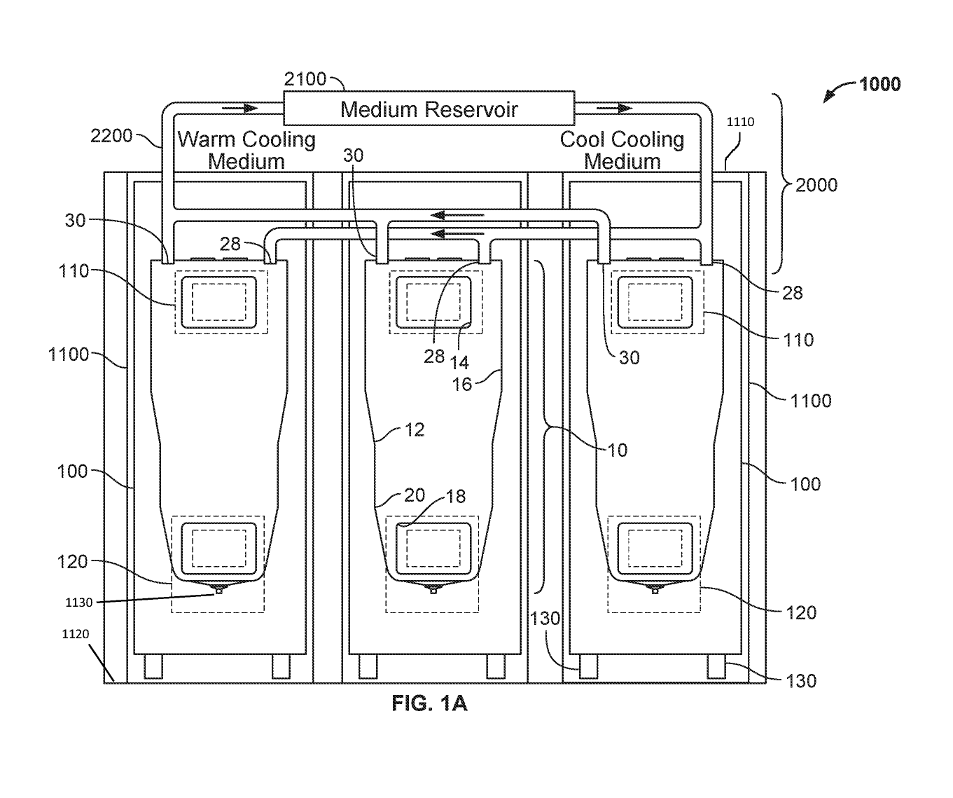

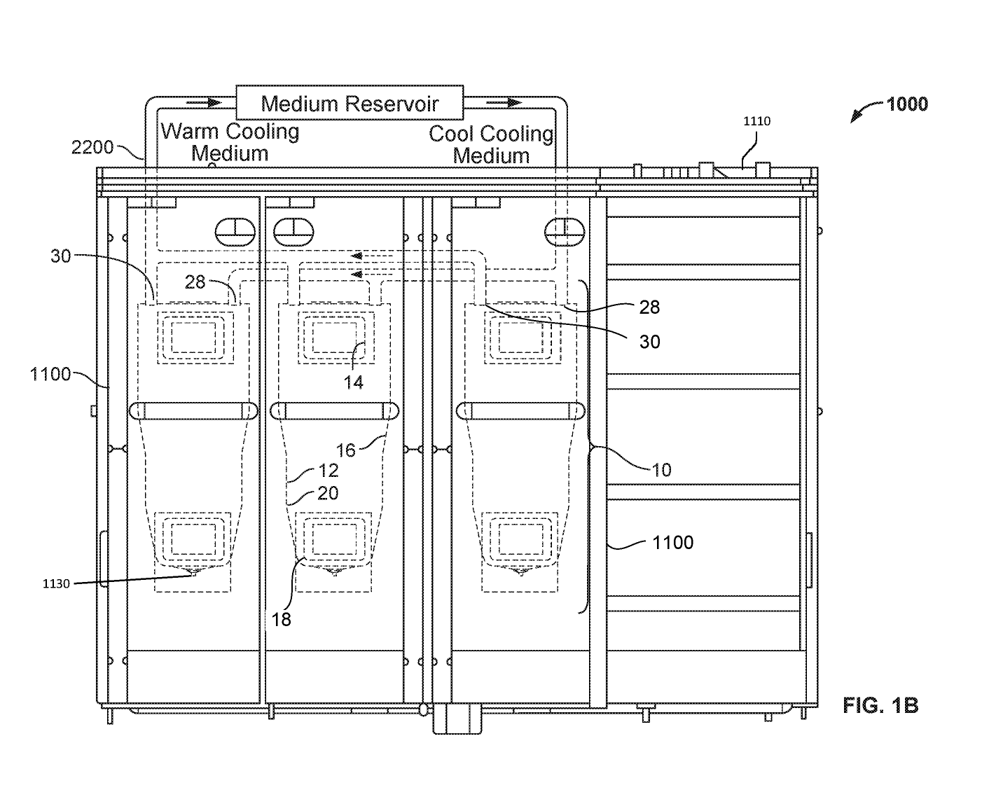

Referring now to FIGS. 1A-B sectional views of an example galley 1000 with cart chillers 10 fed by a cooling system 2000 of an aircraft, according to certain aspects of the disclosure, are illustrated. The galley 1000 can include compartments 1100 to receive carts 100 below a work deck or countertop 1110, a cart chiller 10 in the compartments 1100 to refrigerate perishable items stored in the carts 100, and a cooling system 2000 to provide to the cart chiller 10 cooling medium and provide refrigeration of the perishable items. The cart chiller 10 can provide refrigeration by circulating air throughout an internal volume of the cart 100 that contained the perishable items and by exchanging heat between the air and the cooling medium.

The cooling system 2000 supplies the cart chiller 10 with a circulated cooling medium. For example, the cooling system 2000 may rely on a closed loop circuit with a distribution manifold 2200 that circulates the cooling medium between a medium reservoir 2100 where heat is rejected and the cart chiller 10 where heat is absorbed. The cooling medium transfers heat from the cart chiller 10 to the medium reservoir 2100 by being heated in the cart 100 and cooled in the medium reservoir 2100. The medium may be a liquid and be water or a mixture of water and glycol. In some implementations, the cooling system 2000 is a central cooling and distribution system capable of supplying cooling medium to the entirety of cart chillers 10 present in the aircraft. In other implementations, the cooling system 2000 supplies the cooling medium to a particular subset of cart chillers 10 present in the aircraft, such as all cart chillers 10 contained in a single row of the galley 1000. The cooling system 2000 may be limited to a small subset or even one cart chiller, for example, to simplify design and control, increase efficiency, and/or limit warming of the cooling medium during circulation of the cooling medium between the medium reservoir 2100 and the cart chiller(s) 10. In a preferred embodiment, the cooling system is a “door chiller” which services all cooled galley equipment proximate a given door of an aircraft (e.g., the forward door immediately aft of the pilot cabin).

The perishable items stored in the carts 100 can be any items that require refrigeration. For example, the perishable items can be food and/or beverage, e.g. food trays, soda cans, stored in the carts 100 before being distributed and served to the passengers of the aircraft.

The carts 100 store the perishable items and/or transport the perishable items. For example, the carts 100 may be trolleys with wheels 130 to be roll on a ground surface of the aircraft and within aisles of the aircraft, as illustrated in FIG. 1. In another example, hand-carried food and/or beverage trays or boxes may be stored within the compartments 1100. In a further example, food and/or beverage receptacles capable of stowing upon or within a galley cart may be chilled within the compartments 1100.

In some embodiments, the carts 100 can include air circulation elements to facilitate air flow through the internal volume of the cart 100. For example, the air circulation elements may be an inlet opening 110 (illustrated as a dashed line representing approximate alignment of the inlet opening cart component with the chiller 10) aligning with supply port 14 to receive cool air provided by the cart chiller 10, and an outlet opening 120 (illustrated as a dashed line representing approximate alignment of the outlet opening cart component with the chiller 10) aligned with return port 18 of the chiller to expel warm air back into the cooling system 2000.

The opening of the supply port 14 and/or the return port 18, in some implementations, is adjustable based upon the type of aircraft trolley used within the aircraft. In some examples, trolley standards include the Atlas, Ace, and KSSU airline trolley standards. The ports 14 and 18 may be cut to align with a particular cart's inlet opening 110 or outlet opening 120.

In another example, housing 12 may be constructed to have a greater height such that during installation ports 14 and 18 can be cut to suit the particular galley and cart combination. In such embodiments the housing 12 would extend substantially the entire distance from the work deck 1110 to the cabin floor 1120. The housing 12 in this embodiment has regions larger than dashed boxes 110 and 120 which are adapted to have but cut to form apertures which correspond to ports 14 and 18.

The drain 1130 is adapted to receive and channel excess fluid, such as condensate, from the system. The drain is connected to a drain tube (not shown) which connects to the galley waste water system or, in some embodiments, the cooling system 2000.

In some embodiments, the carts 100 are insulated to maintain refrigerated perishable items. For example, the carts 100 may be provided with insulating elements that provide a substantially airtight seal to prevent the escape of cold air from the carts 100 and thermally insulative layers to prevent conduction of heat through the walls and doors of the cart 100. For example, the insulating elements can be insulated layers made of insulated materials, e.g. polyurethane and/or cellulose foams, to limit heat conduction.

The individual cart bays 1100 may additionally or alternatively be substantially sealed and insulated. For example, the cart bays 1100 may be provided with insulating elements that provide a substantially airtight seal to prevent the escape of cold air from the cart bays 1100 and thermally insulative layers to prevent conduction of heat through the walls and doors of the cart bays 1100. For example, the insulating elements can be insulated layers made of insulated materials, e.g. polyurethane and/or cellulose foams, to limit heat conduction.

The components of the cart chiller 10, in some implementations, are encased in a housing or plenum 12. Portions of the housing or plenum 12 may be made of a light-weight, sturdy polymer, such as Delrin. In some embodiments, portions of the housing or plenum 12 are metallic, e.g. aluminum. The housing or plenum 12 may include the supply port 14 located at the upper portion 16 and configured to be in communication with the inlet opening 110 of the cart 100 and the return port 18 at the bottom portion 20 configured to be in communication with the outlet opening 120 of the cart 100.

In some embodiments, the supply port 14 and/or the return port 18 are covered by filters to prevent dust, insects, and vermin from gaining access to the chiller's components or gaining access to the perishable items stored in an adjacent cart. In certain embodiments, the filters are readily replaceable and adapted to be replaced at routine servicing intervals.

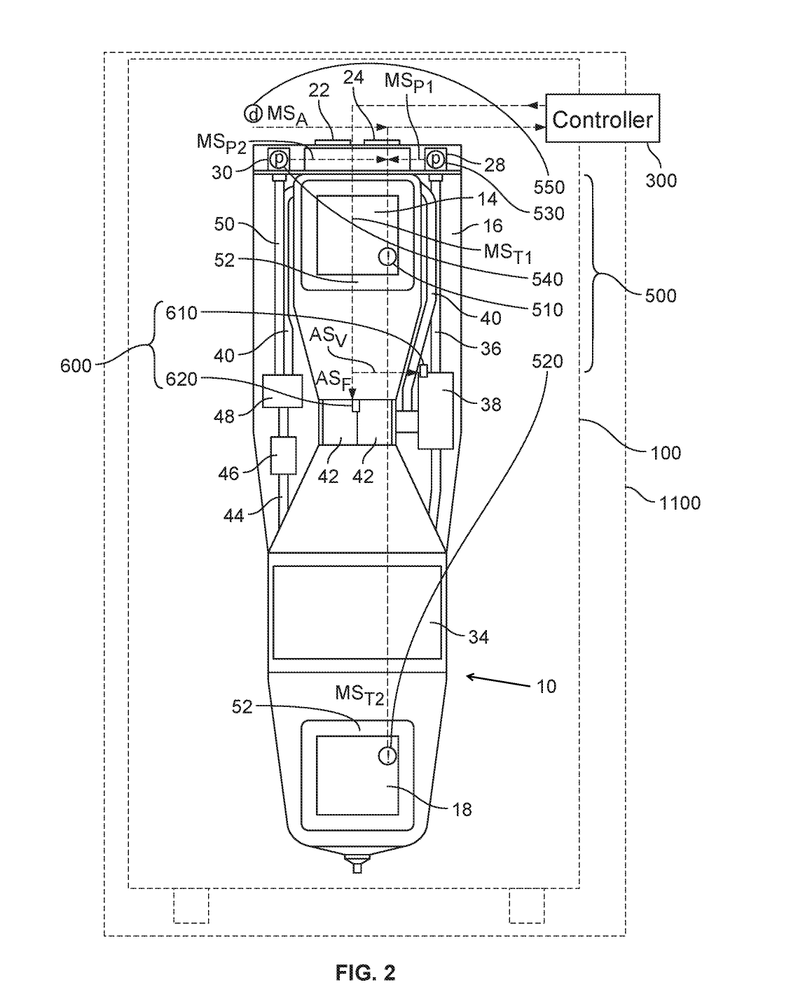

Referring now to FIG. 2, a front view of the cart chiller 10 without the housing or plenum 12 is illustrated. The components and their relationship with each other become readily apparent. The upper portion 16 of the cart chiller 10 includes a first port 22 for connecting power to the unit and a second port 24 for communications/data exchange. The first port 22 can be connected to the main galley power distribution network, which is typically a three phase voltage system that complies with FAA regulations, to provide power to the components of the cart chiller 10.

Also at the upper surface of the cart chiller 10 is an inlet 28 and an outlet 30 for circulating the cooling medium through the cart chiller 10. The cooling medium can be cycled through a heat exchanger 34 to absorb heat from the air circulating through the cart 100. The inlet 28 for the cooling medium, in some embodiments, is connected via a supply conduit 36 to a three way proportioning valve 38 for controlling quantities of cooling medium flowing through the cart chiller 10. A first amount of cooling medium flows through the heat exchanger 34, and a second amount of cooling medium is routed back through a bypass line 40, thereby avoiding circulation through the heat exchanger 34.

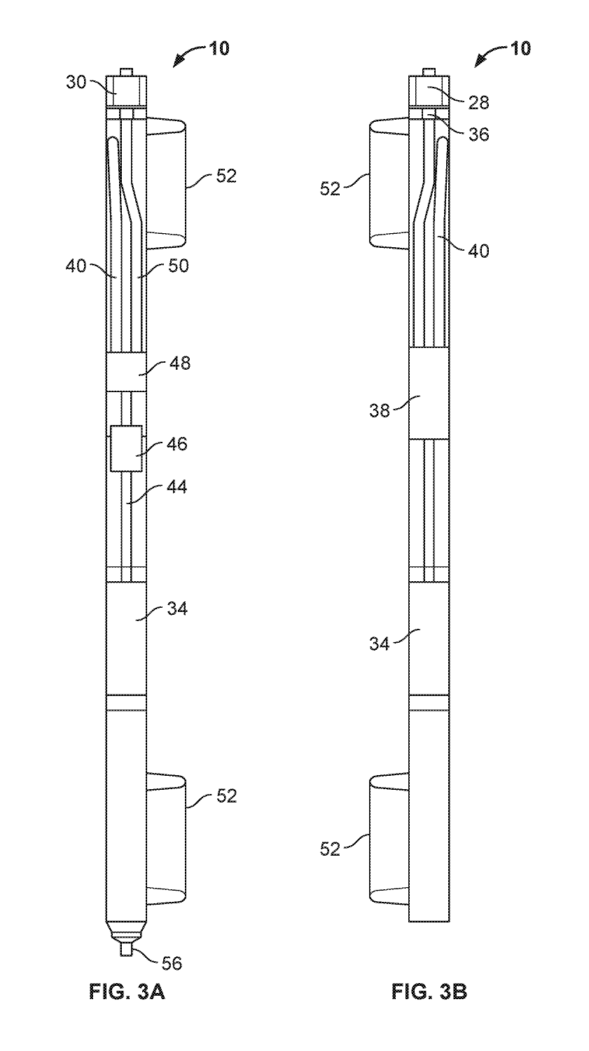

Air, in some embodiments, is drawn in through the return port 18 using one or more fans 42, such as low profile brushless DC blower fans, carrying the air over the heat exchanger 34 and cooling the air as the cooling medium cools the heat exchanger 34. Embodiments using axial fans will generally provide increased flow rate at lower pressure. Embodiments using centrifugal fans generally provide increased pressure and lower flow rates. In a preferred embodiment, the axial blower fan has a depth (the lateral dimension of FIGS. 3A and 3B) of about 10-30 mm and in more preferred embodiments about 15-20 mm.

The heat exchanger 34 can be configured to provide efficient thermal performance to refrigerate the cart 100. For example, the heat exchanger 34 can be a twelve row heat exchanger that circulates the cooling medium as warm returning air is directed over coils of the heat exchanger 34, thereby cooling the air. The cooling medium, in some embodiments, is carried away from the heat exchanger 34 through a return valve 46 and a supply line 44, which includes a three way flow distribution block 48 to recirculate the cooling medium into the cooling system 2000, as illustrated in FIG. 1, and/or into adjacent cart chillers 10. The flow distribution block 48 may include a path 50 to the outlet 30 of the cart chiller 10 on the top of the unit, where the cooling medium is then routed to the cooling system 2000, as illustrated in FIG. 1. A second inlet to the distribution block 48 may include the conduit from the bypass line 40.

The fans 42 adjacent the heat exchanger 34, in some embodiments, draw the warmer air across the heat exchanger 34 through the return port 18 and then blow the cooled air back through the supply port 14 and directly into the internal volume of the cart 100 via an interlock.

In a preferred embodiment, however, a seal 52 is placed around the supply port 14 and the return port 18 to reduce or eliminate leakage and losses at a juncture of the cart 100 and the cart chiller 10. In addition, to further reduce or eliminate leakage, supplementary seals may be placed around the inlet opening 110 of the cart 100 and the outlet opening 120 of the cart 100, as illustrated in FIG. 1.

The cart chiller 10 and/or cooling system 2000, in some embodiments, includes a controller 300 to monitor the refrigeration of the cart 100 via sensors 500, and to adjust the refrigeration of the cart 100 via actuators 600. In some embodiments, the sensors 500 are configured to provide to the controller 300 monitoring signals indicative of refrigeration conditions of the cart 100, e.g. temperatures of air circulating through the cart 100, and/or pressures of the cooling medium circulating through the cart chiller 10. For example, the sensors 500 can include a supply temperature sensor 510 to provide to the controller 300 temperature signals MS_{T1} indicative of temperatures of air going through the supply port 14, a return temperature sensor 520 to provide to the controller 300 temperature signals MS_{T2} indicative of temperatures of air going through the return port 18, an inlet pressure sensor 530 to provide to the controller 300 pressure signals MS_{P1} indicative of pressures of the cooling medium at the inlet 28, an outlet pressure sensor 540 to provide to the controller 300 pressure signals MS_{P2} indicative of pressures of the cooling medium at the outlet 30, and a presence sensor 550, e.g., infrared detector and/or optic detector, to provide to the controller 300 signals MS_{A} indicative of presence and/or absence of the cart 100 inside the compartment 1100 of the galley 1000.

In some embodiments, the control units 600 are configured to receive from the controller 300 actuation signals indicative of refrigeration adjustments for the cart 100, e.g., deactivation and/or activation of the refrigeration, increases and/or decreases of air flow and/or cooling medium quantities. For example, the control units 600 can include a three way valve controller 610, such as a solenoid, which actuates the three way proportioning valve 38, to receive the valve signals AS_{V} and accordingly adjust the first amount of the cooling medium that is directed to the heat exchanger 34 and the second amount of the cooling medium that is directed to the bypass line 40. In another example, the control units 600 can include a fan actuator 620, such as a power switch, and/or a TRIAC bidirectional/bilateral triode thyristor, to receive fan signals AS_{F} and accordingly adjust a speed of the fan(s) 42 and an amount of air that goes through the cart 100.

The use of the power switch as the fan actuator 620 may provide more reliable and simplified operations for the cart chiller 10 as the power switches rely on robust mechanisms that turn on or off the power feeding the fans 42. Conversely, use of the TRIAC as the fan actuator 620 may provide more precise and reactive adjustments of the fans 42 as the TRIAC would adjust the power feeding the fans through substantially small and successive increments.

In some embodiments, the controller 300 is configured to adjust the amount of air that goes through the cart 100, via the fan actuator 620 of the fan(s) 42, based and the temperature signals MS_{T1}, MS_{T2} provided by the supply temperature sensor 510 and the return temperature sensor 520. For example, the amount of air flow that goes through the cart 100 can be commensurate, e.g. proportional, with a temperature gradient between the temperature of air that flows through the return port 18 and the temperature of air that flows through the supply port 14, for example as calculated by the controller 300 based upon the temperature signals MS_{T1}, MS_{T2} provided by the supply temperature sensor 510 and the return temperature sensor 520.

In some embodiments, the controller 300 is configured to adjust the amount of air flow through the cart 100, via the fan actuator 620 of the fan(s) 42. The fan speed(s), for example, may be determined by the controller 300 based on the pressure signals MS_{P1},MS_{P2} provided by the inlet pressure sensor 530 and the outlet pressure sensor 540. For example, the amount of air flow through the cart 100 can be inversely commensurate, e.g. inversely proportional, with a pressure gradient between pressures of the cooling medium that goes through the inlet 28 and the outlet 30. The pressure gradient, for example, can be calculated by the controller 300 from the pressure signals MS_{P1}, MS_{P2}provided by the inlet pressure sensor 530 and the outlet pressure sensor 540.

In some embodiments, the controller 300 is configured to adjust the amount of cooling medium that goes through the heat exchanger 34 and/or, conversely, an amount or proportion of cooling medium to divert from flowing through the heat exchanger 34. For example, the controller 300 may adjust the amount of cooling medium flowing through the heat exchanger 34 via the valve actuator 610 of the three-way proportioning valve 38 based and the temperature signals MS_{T1}, MS_{T2} provided by the supply temperature sensor 510 and the return temperature sensor 520. For example, the amount of cooling medium going through the heat exchanger 34 can be commensurate, e.g. proportional, with a temperature gradient between the temperatures of air that goes through the return port 18 and the temperatures of air that goes through the supply port 14 calculated by the controller 300 from the temperature signals MS_{T1}, MS_{T2} provided by the supply temperature sensor 510 and the return temperature sensor 520.

In some embodiments, the controller 300 is configured to adjust the amount of cooling medium that goes through the heat exchanger 34. For example, the controller 300 may adjust the amount of cooling medium flowing through the heat exchanger 34 via the valve actuator 610 of the three way proportioning valve 38. The controller 300 may determine a setting for the amount of cooling medium flowing through the heat exchanger 34 based on the pressure signals MS_{P1}, MS_{P2} provided by the inlet pressure sensor 530 and the outlet pressure sensor 540. For example, the amount of cooling medium that goes through the heat exchanger 34 can be commensurate, e.g., proportional, with a pressure gradient between pressures of the cooling medium that goes through the inlet 28 and the outlet 30 calculated by the controller 300 from pressure signals MS_{P1}, MS_{P2} provided by the inlet pressure sensor 530 and the outlet pressure sensor 540.

In some embodiments, the controller 300 is configured to activate or deactivate the cart chiller 10 based on the presence signals MS_{A} provided by the presence sensor 550. For example, the fans 42 can be deactivated, via the fan actuator 620 of the fans 42, when the presence signals MS_{A} provided by the presence sensor 550 indicate the absence of the cart 100 in the compartment 1100 and activated, via the fan actuator 620 of the fans 42, when the presence signals MS_{A} provided by the presence sensor 550 indicate the presence of the cart 100 in the compartment 1100. In another example, the three way proportioning valve 38 can be actuated, via the valve actuator 610, to prevent the cooling medium from circulating through the heat exchanger 34 and to bypass the entirety of the cooling medium through the bypass line 40 when the presence signals MS_{A} provided by the presence sensor 550 indicate the absence of the cart 100 in the compartment 1100.

In some embodiments, the controller 300 can be connected to additional circuitry and/or control systems of the aircraft to receive supplementary signals and/or data relevant to the management of the cooling system 2000. The supplementary signals and/or data, for example, may be relevant to maintaining cart bay temperatures to protect perishable items, and/or to adjusting the cooling system 2000 to divert resources, such as power resources, to higher priority systems within the aircraft. The supplementary signals and/or data, in some examples, may be indicative of ambient cabin temperature, external temperature, humidity conditions, and/or travel phases (e.g., pre-flight phase, taxi-out phase, take-off phase, cruising phase, landing phase, and/or taxi-in phase).

In an illustrative example, during the pre-flight phase when perishable items that are already refrigerated (e.g. chilled below a threshold temperature by an on-ground refrigeration mechanism), are loaded into the aircraft and exposed to high temperature ambient air, the controller 300 may be configured to adjust the refrigeration by maximizing the amount of air flow going through the cart 100 and by maximizing the amount of cooling medium going through the heat exchanger 34. Conversely, if the cart is not subjected to a warm ambient environment during loading operations the refrigeration may be minimized to conserve energy. In another example, during the cruising phase, the controller 300 may adjust the refrigeration by increasing the amount of cooling medium that goes through the heat exchanger 34, rather than increasing the amount of air flow going through the cart 100 to reduce noise generated by the chiller. In still a further example, when there is increased demand for coolant from the cooling system 2000, the controllers may increase fan speed and throttle down the amount of fluid passed to the heat exchangers 34. This may permit the use of a less expensive, lighter, and smaller refrigeration unit and/or compressor in cooling system 2000.

Referring now to FIGS. 3A-3B, side views of the cart chiller 10, according to certain aspects of the disclosure, are illustrated. The cart chiller 10 can include a condensation drain fitting 56 disposed centrally for collecting and directing condensation to a waste water disposal port as part of the aircraft's gray water system. The inlet 28 and outlet 30 at the top of a right side and a left side of the cart chiller 10, respectively, have associated conduits 36, 50 that lead to the proportioning valve 38 and the distribution block 48. In a preferred embodiment, the chiller 10 is of substantially the same height as the cart bay, which is an alternative to the configuration shown in FIGS. 1 and 2. In preferred embodiments the width of chiller 10 (the lateral dimension of FIG. 3) is about 1.5 to 2 inches, compared to about 4 inches in previously available chillers. In other embodiments the width of chiller 10 is 1 to 3 inches, 1.25 to 2.75 inches, 1.75 to 2.25 inches, or 1.75 to 2 inches.

The seals 52 mate with complementary seals (not shown) disposed on the aft portion of the carts. Because of the novel control systems provided herein, there is no need to provide ports 14 and 18 (here defined by seals 52) with actuating doors or baffles. In previous chiller solutions, the inlet and outlet ports were equipped with doors which opened when a cart was “connected” to the ports and shut when the cart was removed or “disconnected” from the ports. This necessitated additional hardware, which increased manufacturing cost, complexity, maintenance cost, as well as vibration and noise.

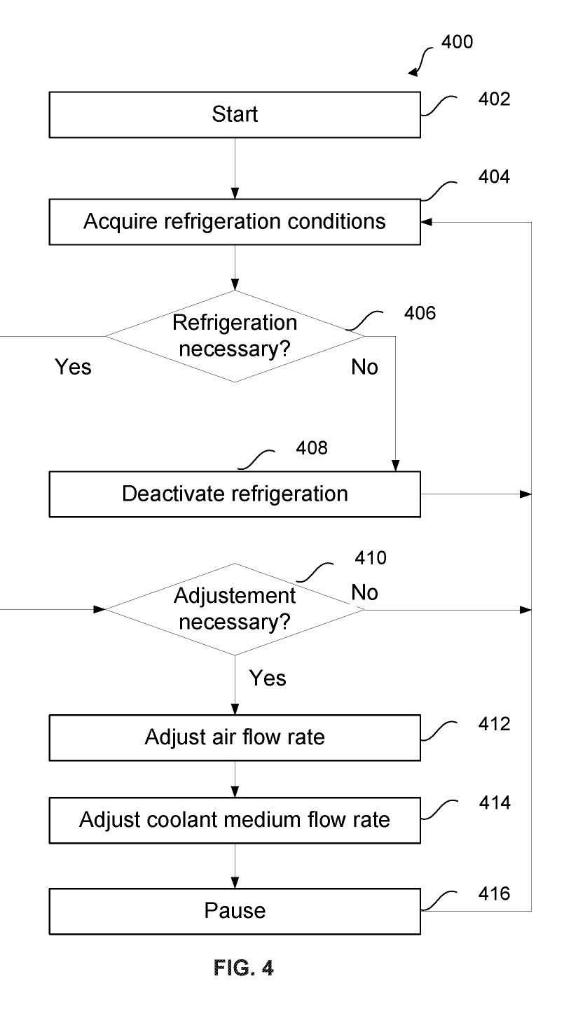

Now referring to FIG. 4, an example method 400 for monitoring and adjusting the refrigeration of one or more chilled galley compartments, according to certain aspects of the disclosure, is illustrated. The method 400, for example, may be performed by the controller 300 as described in relation to FIG. 2.

In some implementations, the method 400 begins with activating management of the refrigeration of chilled galley compartments (402). In one example, control system activation (e.g., upon readying the aircraft for deployment) may activate refrigeration management of the chilled galley compartment(s). In another example, a user interface provided at the aircraft galley itself may include a manual control for activation of refrigeration management.

In some implementations, refrigeration conditions are acquired (404). The monitoring signals indicative of the refrigeration conditions of the galley cooling system, for example, can be provided by the sensors disposed within the galley compartment and/or proximate cooling system components. The conditions, for example, may be extracted and/or calculated from a number of sensor signals into refrigeration conditions through software instructions executed by a controller such as the controller 300 described in relation to FIG. 2. Refrigeration management may include the monitoring of refrigeration output (e.g., air pressures, temperatures and flow rates and cooling medium pressures, temperatures and flow rates). For example, as described in relation to FIG. 2, temperature gradients and/or temperature differences between air going through the supply port 14 and air going through the return port 18 can be calculated and recorded on a memory 304 of the controller 300 via software instructions executed by the controller 300, In another example, refrigeration management may include the monitoring of refrigeration system functionality. For example, as described in relation to FIG. 2, pressure gradients and/or pressure differences between cooling medium going through the inlet 28 and cooling medium going through the outlet 30 can be calculated and recorded on the memory 304 of the controller 300 via software instructions executed by the controller 300.

In an illustrative example, presence signals MS_{A} indicative that the cart 100 is not present in the compartment 1100 can be provided by the presence sensor 550 and extracted into absence conditions of the cart 100 through software instructions executed by the controller 300.

In another example, temperature signals MS_{T1}, MS_{T2} can be provided by the supply temperature sensor 510 and the return temperature sensor 520 and be extracted into the temperature gradient between the temperatures of air going through the return port 18 and the temperatures of air going through the supply port 14 through software instructions executed by the controller 300.

In another example, the pressure signals MS_{P1}, MS_{P2} can be provided by the inlet pressure sensor 530 and the outlet pressure sensor 540 and be extracted into the pressure gradient between the inlet 28 and the outlet 30 through software instructions executed by the controller 300.

In some implementations, it is determined whether refrigeration of the galley compartment(s) is necessary (406). Necessity of refrigeration may be determined, for example, by software instructions executed by the controller 300 based upon the refrigeration conditions. For example, the controller 300 can be configured to determine that the refrigeration is unnecessary when the presence signals MS_{A} received by the controller 300 indicate absence of a cart and/or storage unit within the chilled compartment. In another example, refrigeration may be deemed unnecessary when the temperature signals MS_{T1}, MS_{T2} receive by the controller 300 indicate a thermal equilibrium (e.g. a temperature gradient and/or a difference below a predetermined minimum threshold). Further, in some implementations, refrigeration may be disabled while a door of a chilled compartment is open. For example, a door sensor may provide a door ajar signal to the controller 300 to identify that a door of compartment 1100 is open.

If it determined that the refrigeration is unnecessary, in some implementations, refrigeration is deactivated in the affected compartment(s) (408) and the method (400) goes back to acquiring new refrigeration conditions (404). For example, refrigeration may be deactivated through the actuators 600 and via software instructions executed by the controller 300. For example, the controller 300 can be configured to send the fan signals AS_{F} to the fan actuator 620 to turn off the fans 42 and/or to send the valve signals ASᵥ to the valve actuator 610 to close the three way proportioning valve 38 and direct the entirety of the cooling medium to the bypass line 40, e.g. minimizing the first amount of the cooling medium while maximizing the second amount of the cooling medium.

If it is determined that refrigeration is needed (406) in some implementations, it is determined whether refrigeration adjustments of the galley compartment(s) are necessary (410). Necessity of refrigeration adjustments may be determined, for example, by software instructions executed by the controller 300 based upon the refrigeration conditions. For example, the controller 300 can be configured to determine that the refrigeration adjustments are necessary when the temperature signals MS_{T1}, MS_{T2} receive by the controller 300 indicate a lack of thermal equilibrium (e.g. a temperature gradient and/or a difference above a predetermined minimum threshold). Customer parameters and/or industry standards, for example, may determine a maximum period of time perishables may be maintained in sub-optimal conditions (e.g., a maximum period of time to reduce the temperature in the chilled compartment to a threshold chilled temperature). In one example, a galley cart compartment and/or galley cart (in the event there is no door on the cart compartment) may need to be chilled to between 2 and 5 degrees Celsius from ambient temperature within four hours. In another example, a galley cart compartment and/or galley cart may need to be chilled to between 2 and 5 degrees Celsius within 90 minutes. In a further example, a perishable items compartment, if raised to at least 6 degrees, may need to be reduced to under 5 degrees Celsius within 20 minutes. To effect heat transfer within prescribed time periods, for example, additional coolant and/or additional air flow may be applied to the compartment to aid in chilling. Further, customer parameters and/or industry standards may dictate maximum temperatures and/or time periods related to a defrost cycle of a chilled compartment or trolley. In one particular example, a defrost cycle may be timed at a maximum of 10 minutes prior to returning to cooling the chilled compartment or trolley.

If it determined that the refrigeration adjustments are unnecessary, in some implementations, the method (400) goes back to acquiring new refrigeration conditions (404).

If it is determined that refrigeration adjustment are needed, in some implementations, the flow rate of air circulation within the galley compartment(s) is adjusted (412). The flow rate of air circulating between the return port 18 and the supply port 14 can be adjusted based on the refrigeration conditions through the fans 42 and via software instructions executed by the controller 300. For example, the controller 300 can be configured to send the fan signals AS_{F} to the fan actuator 620 of the fans 42 to increase a speed of the fans 42 as the temperature gradients extracted by the controller 300 indicate lack of thermal equilibrium(e.g., a temperature gradients above the predetermined thermal equilibrium threshold) and/or as the pressure gradients extracted by the controller 300 indicate a failure of the cooling medium(e.g. a pressure difference between the inlet 28 and the outlet 30 below a predetermined minimum pressure threshold). Conversely, fan speed may be decreased based upon evidence that the contents of the chilled compartment are reaching thermal equilibrium or additional cooling medium resources come available. Activation of the fans and/or increasing the fan speed can increase thermal transfer to more quickly cool perishable items without introducing additional coolant. The determination to increase fan speed, for example, may be based in part upon a limit of the available coolant to supply to the chilled compartment (e.g., other stresses on the cooling system are demanding proportioning of available coolant) and/or noise constraints within the cabin area.

In some implementations, the flow rate of cooling medium circulating within the cart chiller 10 is adjusted (414). For example, the first quantity of cooling medium can be adjusted based on the refrigeration conditions through the three way proportioning valve 38 and via software instructions executed by the controller 300. For example, the controller 300 can be configured to send the valve signals AS_{V} to the valve actuator 610 of the three way proportioning valve 38 to increase the first quantity of cooling medium as the temperature gradients extracted by the controller 300 indicate a lack of thermal equilibrium, (e.g. temperature gradients above the predetermined threshold, and/or as a maximum speed of the fan 42 is reached). The amount of coolant, in some embodiments, may be increased without adjustment of the fan speed, for example to avoid increased noise in the cabin during flight. Conversely, if there is evidence that the contents of a chilled compartment are reaching thermal equilibrium, coolant may be diverted away from the chilled compartment and made available to other cooling systems within the galley.

In some implementations the method 400 is paused (416). For example, the method 400 can be paused during a predetermined period such that the adjustments of the refrigeration (e.g., adjustments to the air flow rate and/or coolant medium flow rate) are felt by the perishable items, e.g. thermal inertia is stabilized or such that client and/or regulation requirements are met. In one example, the length of the pause may be around 30 seconds, 1 minute, or 5 minutes. In some embodiments, industry standards and/or customer requirements may dictate that temperatures rise above the target temperature (e.g., between 2 and 6 degrees Celsius) for no more than 10 minutes. These parameters may guide monitoring frequency to ensure quality standards are met.

The method 400, in some implementations, continues to return to acquiring refrigeration conditions (404) and responding to the refrigeration conditions until the cooling system is taken offline (e.g., the aircraft is placed out of service).

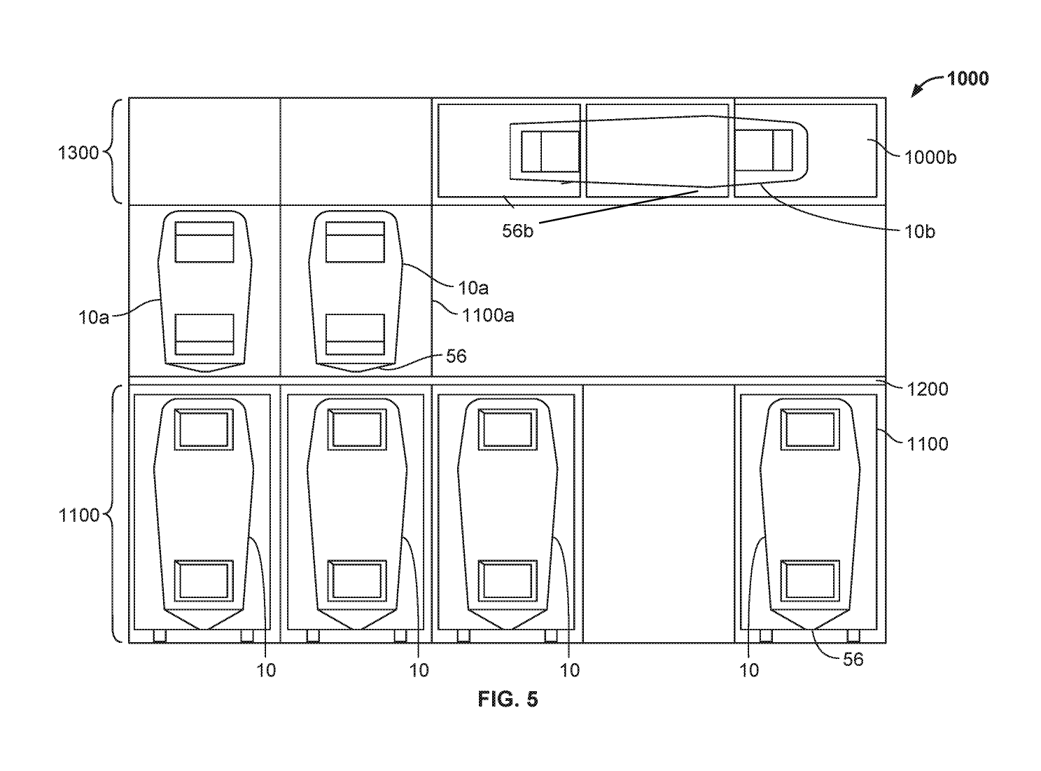

Referring now to FIG. 5, a sectional view of the galley 1000 with the cart chillers 10, compartment chillers 10a, and meal box chillers 10b, according to certain aspects of the disclosure, is illustrated. In some embodiments, in addition to the cart chillers 10, the galley 1000 can include other types of chillers to provide refrigeration to containers other than the carts 100. For example, the galley 1000 can include compartment chillers 10a to provide refrigeration of deck compartments 1100a and meal box chillers 10b to provide refrigeration of meal boxes 1100b. In some embodiments, the cart chillers 10, the compartment chillers 10a, and the meal box chillers 10b can have each different geometrical characteristics, e.g. locations, orientations, and/or dimensions, which correspond to physical characteristics of the containers, e.g. the carts 100, the deck compartments 1100a, and the meal boxes 1100b. For example, the cart chillers 10 can be located between a ground surface of the aircraft and a work deck 1200 of the galley 1000 in a substantially vertical orientation and can extend along a height of the cart 100 to face the perishable items stored within cart 100. The cart 100, in some embodiments, includes mating seal mechanisms to allow circulation of cooling air flow within the cart 100 while docked within the galley compartment, while upon removing the cart 100 from the galley compartment the seals close to maintain temperature of the contents within.

In another example, the compartment chillers 10a can be located above the work deck 1200 in a substantially vertical orientation and along a height of the deck compartment 1100a to face the deck compartment 1100a that may be located at chest height and the perishable items that can be stored within the deck compartment 1100a.

In a final example, the meal box chillers 10b can be located above the work deck 1200 (e.g., above deck compartments 1100a and/or above a work area usable by aircraft personnel) in a substantially horizontal orientation along a length of a number of adjacent meal box standard unit compartments 1100b (e.g., three as illustrated). The adjacent meal box standard unit compartments 1100b, for example, may include openings between each compartment to facilitate air circulation. The meal box chillers 10b may be disposed at the rear of a meal box bay 1300 and facing perishable items that can be stored within the meal box standard unit compartments 1100b.

The compartment chillers 10a and the meal box chillers 10b are similar to the cart chillers 10 with similar elements. In some examples, compartment chillers 10a may include the inlet 28, the outlet 30, the supply port 14, the return port 18, the three way proportioning valve 38, the heat exchanger 34, the sensors 500, the actuators 600, and/or the controller 300, as described in relation to FIGS. 1 through 3B. However, the compartment chillers 10a and the meal box chillers 10b may differ from the cart chillers 10 on how air is employed to provide refrigeration to the perishable items. The compartment chillers 10a and the meal box chillers 10b can employ an air around type of refrigeration while the cart chillers 10 can employ an air through type of refrigeration. In air though refrigeration type provided by the cart chillers 10, the air is circulating inside an internal volume of the cart 100, while in the air around refrigeration type provided by the compartment chillers 10a and the meal box chillers 10b, the air is circulated around an internal volume of the deck compartment 1100a and around the meal box standard unit compartments 1100b, respectively. In addition, due to the substantially horizontal orientation of the meal box chillers 10b, the meal box chillers 10b may include a condensation drain fitting at location 56b. As for the condensation drain fitting 56, the side condensation drain fitting 56b may be configured to collect and direct condensation to a waste water disposal port as part of a gray water system of the aircraft.

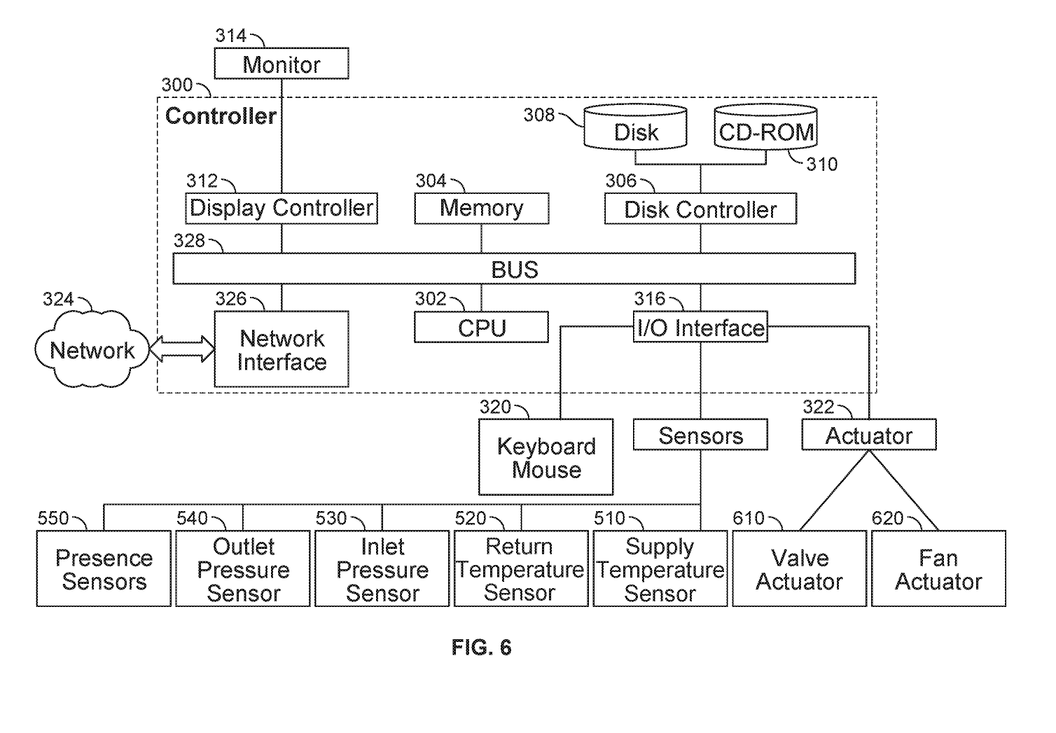

Referring now to FIG. 6, a schematic view of an example hardware diagram of the controller 300 for monitoring and adjusting the refrigeration, according to certain aspects of the disclosure, is illustrated. Systems, operations, and processes in accordance with this disclosure may be implemented using the processor 302 or at least one application specific processor (ASP). The processor 302 may utilize a computer readable storage medium, such as the memory 304 (e.g.,, ROM, EPROM, EEPROM, flash memory, static memory, DRAM, SDRAM, and their equivalents), configured to control the processor 302 to perform and/or control the systems, operations, and processes of this disclosure. Other storage mediums may be controlled via a disk controller 306, which may control a hard disk drive 308 or optical disk drive 310.

The processor 302 or aspects thereof, in an alternate embodiment, can include or exclusively include a logic device for augmenting or fully implementing this disclosure. Such a logic device includes, but is not limited to, an application-specific integrated circuit (ASIC), a field programmable gate array (FPGA), a generic-array of logic (GAL), and their equivalents. The processor 302 may be a separate device or a single processing mechanism. Further, this disclosure may benefit form parallel processing capabilities of a multi-cored processor.

The controller 300 can include a display controller 312 that controls a monitor 314. The monitor 314 may be peripheral to or part of the controller 300. The display controller 312 may also include at least one graphic processing unit for improved computational efficiency.

Moreover, the monitor 314 may be provided with a touch-sensitive interface to a command/instruction interface.

Additionally, the controller 300 may include an I/O (input/output) interface 316, provided for the monitoring signals, e.g. the absence signals MS_{A}, the temperature signals MS_{T1}, MS_{T2}, and/or the pressure signals MS_{P1}, MS_{P2} from the sensors 500, e.g., the supply temperature sensor 510, the return temperature sensor 520, the inlet pressure sensor 530, the outlet pressure sensor 540, and/or the presence sensor 550, and for outputting actuation signals, e.g. the fan signals AS_{F}, and/or the valve signals AS_{V}, to actuators 600, e.g., the valve actuator 610 and/or the fan actuator 620.

Further, other input devices may be connected to an I/O interface 316 as peripherals or as part of the controller 300. For example, a keyboard or a pointing device such as a mouse 320 may control parameters of the various processes and algorithms of this disclosure, and may be connected to the I/O interface 316 to provide additional functionality and configuration options, or to control display characteristics.

The above-noted hardware components may be coupled to a network 324, such as the Internet or a local intranet, via a network interface 326 for the transmission or reception of data, including controllable parameters to a mobile device. A central BUS 328 may be provided to connect the above-noted hardware components together, and to provide at least one path for digital communication there between.

One advantage of the preferred embodiment is the high capacity of the chillers 10, 10a, 10b in a compact footprint. As shown in FIGS. 3A-3B, the chillers 10, 10a, 10b occupy less space than traditional aircraft chillers, while fulfilling all of the requirements for the preservation of perishable items and the like on long distance flights. Specifically, various embodiments of compact liquid cooled, air through galley chillers may significantly reduce the space required for the effective chilling (refrigeration) of standard beverage/food carts, on aircraft using chilled liquid as a cooling medium. Particular efficiency may be gained, for example, where “air through” aircraft carts are employed, since the seals and inlets/outlets of chillers may be customized to align with the “Air Through” venting of such carts. The chillers 10, 10a, 10b of the present disclosure may allow the depth of a conventional aircraft catering galley to be reduced by 3 to 4″ (75 to 100 mm) while maintaining full effectiveness.

Another advantage of the preferred embodiment is reduction of the depth of an air-through chiller module to, in a most preferred embodiment, 1.65 inches (42 mm), allowing the reduction in the overall depth of a galley when compared with a galley employing conventional air through beverage/food carts. The compact and efficient nature of the chiller provides for independent and individual chilling of each cart bay according to the thermal demand. Moreover, the location of the distribution manifolds at the top of the chilled cart bays towards the rear of the work deck 1200 provides an easy and convenient system for integrating with the cooling system 2000 of the galley 1000, as illustrated in FIG. 1. Efficiency is promoted through the distribution of the air inside the cart 100 by means of flow efficient ductwork, where warmer air is chilled and recirculated through the compartment 1100. Various embodiments discussed within provide significant reductions in weight through the use of plastics and light weight composite materials, and energy efficiency through the use of a combination of liquid flow proportioning via the three way proportioning valve 38, and adjustable fan speed to control the chilling capability (BTU output) of each individual module. The use of the condensate drains 56, 56b removes excess condensed water from the case of the air cooling module for safety and health concern, and the elimination of the requirement for air control flaps through the use of a cart actuated interlock device saves costs while aiding in prevention of heat losses.

The foregoing detailed description of the innovations included herein is not intended to be limited to any specific figure or described embodiment. One of ordinary skill would readily envision numerous modifications and variations of the foregoing examples, and the scope of the present disclosure is intended to encompass all such modifications and variations. Accordingly, the scope of the claims presented is properly measured by the words of the appended claims using their ordinary meanings, consistent with the descriptions and depictions herein.

What is claimed is:

1. A system for cooling contents of a galley compartment of an aircraft, comprising:
a chiller unit comprising
a housing having a height, width and depth, the depth being two inches or less,
an inlet to receive a cooling medium from a refrigeration system positioned remotely from the chiller unit,
a three way proportioning valve connected to the inlet for splitting the cooling medium into a first flow of cooling medium and a second flow of cooling medium, the first flow being routed to a heat exchanger and the second flow being routed to a bypass line;
an outlet to return the cooling medium to the refrigeration system;
a supply port to channel cool air into the internal volume of a cart adjacent the supply port,
a return port to receive warm air from an internal volume of the cart, and
at least one fan for moving air between the return port and the supply port;
at least one proximity sensor disposed within or proximate the chiller apparatus; and
a controller comprising processing circuitry configured to
receive, from the at least one sensor, at least one refrigeration condition,
determine, based at least in part upon the at least one refrigeration condition, at least one chiller unit setting, and
issue, to the chiller unit, signals activating the at least one chiller unit setting.
